(19) United States
(12) Patent Application Publication
(10) Pub. No.: US 2014/0336901 A1
(43) Pub. Date: Nov. 13, 2014

(54) HIGH-PRESSURE FUEL PUMP PROTECTION

(71) Applicant: Ford Global Technologies, LLC, Dearborn, MI (US)

(72) Inventors: James Braden Roberts, Fisherville, KY (US); Kevin Bird, South Lyon, MI (US); Thomas Billings, Northville, MI (US); Ace Koua Kue, Franklin, MI (US); James Joseph Moylan, Louisville, KY (US); Brien Lloyd Fulton, West Bloomfield, MI (US); Carlos Armesto, Canton, MI (US)

(73) Assignee: Ford Global Technologies, LLC, Dearborn, MI (US)

(21) Appl. No.: 13/891,026

(22) Filed: May 9, 2013

(51) Int. Cl. F02D 41/38

(52) U.S. Cl. CPC F02D 41/3827
USPC 701/102

(57) ABSTRACT

A method to protect a high-pressure fuel pump in a diesel-engine system includes enabling the high-pressure fuel pump when fuel pressure in the diesel-engine system is above a threshold, and disabling the high-pressure fuel pump if the fuel pressure is below the threshold. In this manner, the high-pressure fuel pump is protected from premature wear and failure due to inadequate lubrication.

### TECHNICAL FIELD

This application relates to the field of motor vehicle engineering, and more particularly, to protecting a high-pressure fuel pump in a diesel-engine system.

### BACKGROUND AND SUMMARY

In a state-of-the-art diesel engine system, a high-pressure fuel pump is used to deliver fuel to a set of fuel injectors. The pump typically includes one or more reciprocating pistons and bearings, which are lubricated by the diesel fuel itself. Accordingly, operation of the pump with an inadequate supply of fuel—i.e., an inadequate inlet fuel pressure—may damage the pump. Damage occurs because air, present in the fuel lines when the fuel supply is inadequate, is not an effective lubricant for the pump. The extent of the damage incurred under such conditions may range from accelerated wear, which shortens the usable lifetime of the pump, to total pump failure.

Startability issues related to inadequate fuel supply to a high-pressure fuel pump are addressed, for example, in U.S. Pat. No. 7,698,054 to Akita et al. In this reference, a high-pressure fuel pump may be driven for an extended duration before engine cranking, to allow time for fuel vapor in the fuel lines to be displaced by the fuel. The determination of how long to delay cranking is based on the fuel temperature and fuel pressure. However, this approach appears to be most applicable to gasoline engines, in which a significant amount of fuel vapor can accumulate in the fuel lines after the engine is turned off. It is less applicable to diesel engines, in which the fuel is less volatile, but where ingress of air in the fuel lines can result in under-lubrication of the high-pressure fuel pump. Moreover, the solution of Akita et al., which involves running the pump with inadequate fuel pressure, is antagonistic to the object of protecting the pump from undue wear and failure.

Accordingly, the inventors herein have devised an alternative approach which is directly applicable to diesel-engine systems. One embodiment provides a method to protect a high-pressure fuel pump in a diesel-engine system. The method includes enabling the high-pressure fuel pump when fuel pressure in the diesel-engine system is above a threshold, and disabling the high-pressure fuel pump if the fuel pressure is below the threshold. In this manner, the high-pressure fuel pump is protected from premature wear and failure due to inadequate lubrication.

The statements above are provided to introduce a selected part of this disclosure in simplified form, not to identify key or essential features. The claimed subject matter, defined by the claims, is limited neither to the content above nor to implementations that address the problems or disadvantages referenced herein.

### BRIEF DESCRIPTION OF THE DRAWINGS

FIG. 1 shows aspects of an example engine system in accordance with an embodiment of this disclosure.

FIG. 2 shows aspects of an example fuel system in accordance with an embodiment of this disclosure.

FIG. 3 illustrates an example method for protecting a high-pressure fuel pump in a diesel-engine system, in accordance with an embodiment of this disclosure.

### DETAILED DESCRIPTION

Aspects of this disclosure will now be described by example and with reference to the illustrated embodiments listed above. Components, process steps, and other elements that may be substantially the same are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

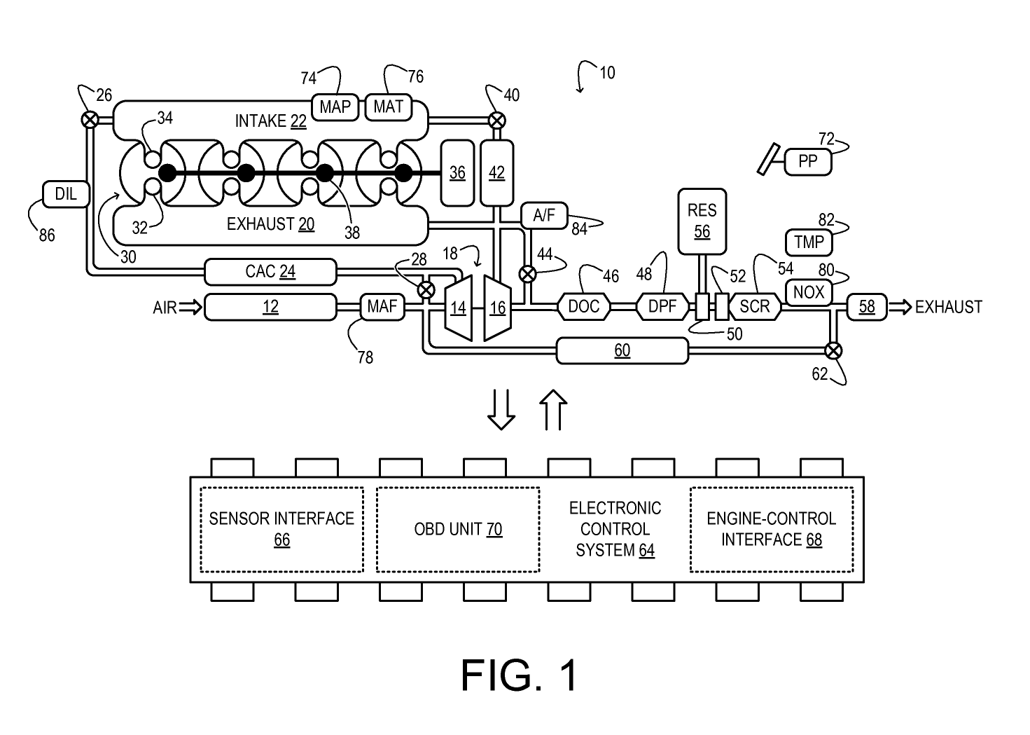

FIG. 1 schematically shows aspects of an example engine system 10 of a motor vehicle. In engine system 10, fresh air is inducted into air cleaner 12 and flows to compressor 14. The compressor may be any suitable intake-air compressor—a motor-driven or driveshaft driven supercharger compressor, for example. In engine system 10, however, the compressor is mechanically coupled to turbine 16 in turbocharger 18, the turbine driven by expanding engine exhaust from exhaust manifold 20.

Compressor 14 is coupled fluidically to intake manifold 22 via charge-air cooler (CAC) 24 and throttle valve 26. Pressurized air from the compressor flows through the CAC and the throttle valve en route to the intake manifold. In the illustrated embodiment, compressor recirculation valve (CRV) 28 is coupled between the inlet and the outlet of the compressor. The compressor recirculation valve may be a normally closed valve configured to open to relieve excess boost pressure under selected operating conditions.

Exhaust manifold 20 and intake manifold 22 are coupled to a series of cylinders 30 through a series of exhaust valves 32 and intake valves 34, respectively. In one embodiment, the exhaust and/or intake valves may be electronically actuated. In another embodiment, the exhaust and/or intake valves may be cam actuated. Whether electronically actuated or cam actuated, the timing of exhaust and intake valve opening and closure may be adjusted as needed for desired combustion and emissions-control performance.

Cylinders 30 may be supplied any of a variety of fuels, depending on the embodiment: diesel or biodiesel, for example. In the illustrated embodiment, fuel from fuel system 36 is supplied to the cylinders via direct injection through fuel injectors 38. In the various embodiments considered herein, the fuel may be supplied via direct injection, port injection, or any combination thereof. In engine system 10, combustion may be initiated via compression ignition in any variant.

Engine system 10 includes high-pressure (HP) exhaust-gas recirculation (EGR) valve 40 and HP EGR cooler 42. When the HP EGR valve is opened, some high-pressure exhaust from exhaust manifold 20 is drawn through the HP EGR cooler to intake manifold 22. In the intake manifold, the high pressure exhaust dilutes the intake-air charge for cooler combustion temperatures, decreased emissions, and other benefits. The remaining exhaust flows to turbine 16 to drive the turbine. When reduced turbine torque is desired, some or all of the exhaust may be directed instead through wastegate 44, by-passing the turbine. The combined flow from the turbine and the wastegate then flows through the various exhaust-aftertreatment devices of the engine system, as further described below.

In engine system 10, diesel-oxidation catalyst (DOC) device 46 is coupled downstream of turbine 16. The DOC device includes an internal catalyst-support structure to which a DOC washcoat is applied. The DOC device is configured to oxidize residual CO, hydrogen, and hydrocarbons present in the engine exhaust.

Diesel particulate filter (DPF) 48 is coupled downstream of DOC device 46. The DPF is a regenerable soot filter configured to trap soot entrained in the engine exhaust flow; it comprises a soot-filtering substrate. Applied to the substrate is a washcoat that promotes oxidation of the accumulated soot and recovery of filter capacity under certain conditions. In one embodiment, the accumulated soot may be subject to intermittent oxidizing conditions in which engine function is adjusted to temporarily provide higher-temperature exhaust. In another embodiment, the accumulated soot may be oxidized continuously or quasi-continuously during normal operating conditions.

Reductant injector 50, reductant mixer 52, and SCR device 54 are coupled downstream of DPF 48 in engine system 10. The reductant injector is configured to receive a reductant (e.g., a urea solution) from reductant reservoir 56 and to controllably inject the reductant into the exhaust flow. The reductant injector may include a nozzle that disperses the reductant solution in the form of an aerosol. Arranged downstream of the reductant injector, the reductant mixer is configured to increase the extent and/or homogeneity of the dispersion of the injected reductant in the exhaust flow. The reductant mixer may include one or more vanes configured to swirl the exhaust flow and entrained reductant to improve the dispersion. Upon being dispersed in the hot engine exhaust, at least some of the injected reductant may decompose. In embodiments where the reductant is a urea solution, the reductant will decompose into water, ammonia, and carbon dioxide. The remaining urea decomposes on impact with the SCR catalyst (vide infra).

SCR device 54 is coupled downstream of reductant mixer 52. The SCR device may be configured to facilitate one or more chemical reactions between ammonia formed by the decomposition of the injected reductant and NOₓ from the engine exhaust, thereby reducing the amount of NOₓ released into the ambient. The SCR device comprises an internal catalyst-support structure to which an SCR washcoat is applied. The SCR washcoat is configured to sorb the NOₓ and the ammonia, and to catalyze the redox reaction of the same to form dinitrogen (N₂) and water.

It will be noted that the nature, number, and arrangement of exhaust-aftertreatment devices in the engine system may differ for the different embodiments of this disclosure. For instance, some configurations may include an additional soot filter or a multi-purpose exhaust-aftertreatment device that combines soot filtering with other emissions-control functions, such as NOₓ trapping.

Continuing in FIG. 1, all or part of the treated exhaust may be released into the ambient via silencer 58. Depending on operating conditions, however, some exhaust may be diverted through low-pressure (LP) EGR cooler 60, before or after emissions-control treatment. The exhaust may be diverted by opening LP EGR valve 62 coupled in series with the LP EGR cooler. From LP EGR cooler 60, the cooled exhaust gas flows to compressor 14.

Engine system 10 includes electronic control system 64 configured to control various engine-system functions. The electronic control system includes machine-readable storage media (i.e., memory) and one or more processors configured for appropriate decision making responsive to sensor input and directed to intelligent control of engine-system componentry. Such decision-making may be enacted according to various strategies such as event-driven, interrupt-driven, multi-tasking, multi-threading, and the like. In this manner, the electronic control system may be configured to enact any or all aspects of the methods disclosed herein, wherein the various method steps—e.g., operations, functions, and acts—may be embodied as code programmed into the machine-readable storage media of the electronic control system.

Electronic control system 64 includes sensor interface 66, engine-control interface 68, and on-board diagnostic (OBD) unit 70. To assess operating conditions of engine system 10 and of the vehicle in which the engine system is installed, sensor interface 66 receives input from various sensors arranged in the vehicle—flow sensors, temperature sensors, pedal-position sensors, pressure sensors, etc. Some example sensors are shown in FIG. 1—accelerator pedal position sensor 72, manifold air-pressure (MAP) sensor 74, manifold air-temperature sensor (MAT) 76, mass air-flow (MAF) rate sensor 78, NOₓ sensor 80, exhaust-system temperature sensor 82, exhaust air-to-fuel ratio sensor 84, and intake-air dilution sensor 86. Various other sensors may be provided as well.

Electronic control system 64 also includes engine-control interface 68. The engine-control interface is configured to actuate electronically controllable valves, actuators, and other componentry of the vehicle—throttle valve 26, CRV 28, wastegate 44, and EGR valves 40 and 62, for example. The engine-control interface is operatively coupled to each electronically controlled valve and actuator and is configured to command its opening, closure, and/or adjustment as needed to enact the control functions described herein.

Electronic control system 64 also includes on-board diagnostic (OBD) unit 70. The OBD unit is a portion of the electronic control system configured to diagnose degradation of various components of engine system 10. Such components may include fuel-system components, for example.

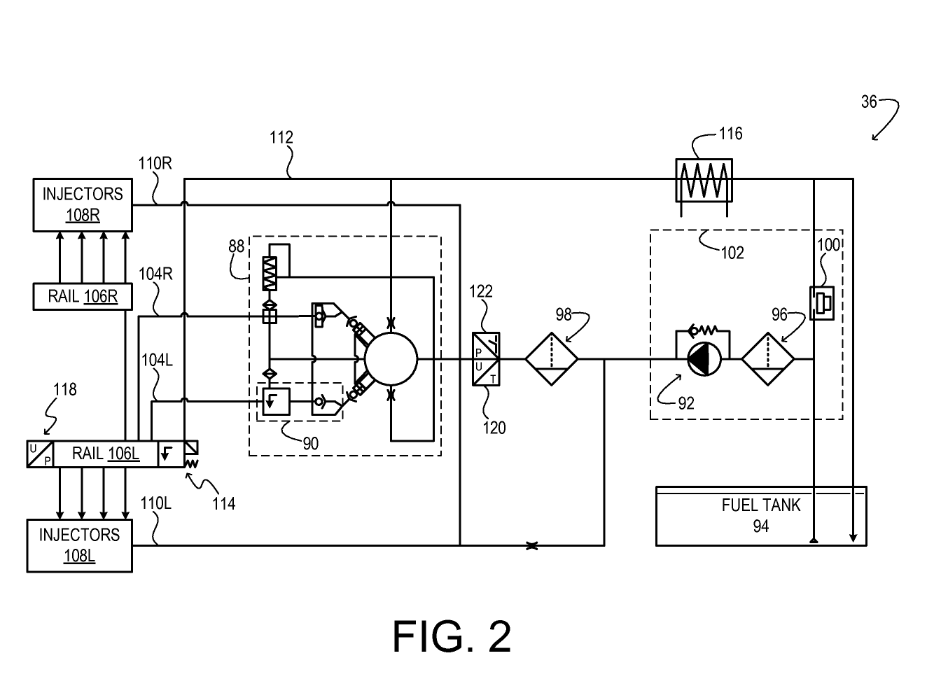

FIG. 2 shows aspects of an example fuel system 36 in one embodiment. The fuel system includes a high-pressure (HP) fuel-injection pump 88. In some embodiments, the HP fuel pump may be rigidly coupled to the engine crankshaft with a pulley or helical gear. In other examples, the HP fuel pump may be selectably coupled via a clutch. In the embodiment of FIG. 2, the HP fuel pump includes volume-control valve (VCV) 90. Lift pump 92 draws diesel fuel from fuel tank 94 and supplies it to the HP fuel pump, suctioning the fuel through primary fuel filter 96 and forcing it though secondary fuel filter 98. In the illustrated embodiment, lift pump 92 and primary fuel filter 96, along with recirculation valve 100 (vide infra) are coupled within diesel-fuel conditioning module (DFCM) 102. In other embodiments, an analogous module may be situated within the fuel tank.

In the embodiment of FIG. 2, the HP fuel pump includes a left-side fuel outlet 104L and a right-side fuel outlet 104R. In this configuration, pressurized fuel from both the left- and right-side outlets flows to left-side fuel rail 106L, which supplies fuel to left-side fuel injectors 108L. From the left side fuel rail, the pressurized fuel also flows to right-side fuel rail 106R, which supplies fuel to right-side fuel injectors 108R. Thus, the fuel system is fluidically coupled to the engine via the left- and right-side fuel rails. Return lines 110L and 110R conduct non-injected fuel from the fuel injectors back to the inlet of the HP fuel pump. A return line 112 is also provided from the left-side fuel rail. This line conducts non-injected fuel from the left-side fuel rail, which is bled off by pressure-control valve (PCV) 114 to control rail pressure. Under normal operating conditions, most of the bled-off fuel is returned to fuel tank 94 via fuel cooler 116. The remainder of the bled-off fuel is returned directly to the HP fuel pump, to provide cooling and lubrication. The opening of recirculation valve 100 redirects fuel that would ordinarily be returned to the fuel tank, returning it instead to the inlet of primary fuel filter 96 under selected conditions—e.g., at low temperatures where performance is improved by retaining as much heat as possible in the recirculating fuel.

Fuel system 36 includes a plurality of sensors: fuel-rail pressure sensor 118, fuel temperature sensor 120, and fuel-delivery pressure sensor 122, for example. In one embodiment, each of the fuel-pressure sensors generates an output signal that varies continuously with the fuel pressure in the conduit to which it is coupled. In other embodiments, at least one of the fuel-pressure sensors may be a pressure switch having, effectively, a Boolean output that switches its state when the fuel pressure traverses a predefined threshold.

No aspect of the foregoing description or drawings should be interpreted in a limiting sense, for numerous other engine and fuel systems are within the spirit and scope of this disclosure. For example, another equally suitable fuel system may include an internal transfer pump (ITP) in lieu of a lift pump. The ITP may be coupled upstream of HP fuel pump 88, such that the portion of the fuel system leading to the ITP is maintained at reduced pressure. In some embodiments, the ITP may include an inlet throttle. Other fuel systems may include both a lift pump and an ITP. Furthermore, any of the fuel filters described above may include additional componentry, such as a water-in-fuel sensor, a water reservoir to temporarily store water removed from the fuel by the fuel filter, and a drain to permanently discharge the stored water.

The configurations described above enable various methods for protecting a high-pressure fuel pump in a diesel-engine system. Accordingly, some such methods are now described, by way of example, with continued reference to the above configurations. It will be understood, however, that the methods here described, and others within the scope of this disclosure, may be enabled by different configurations as well. The methods may be entered upon any time engine system 10 is operating, and may be executed repeatedly. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description.

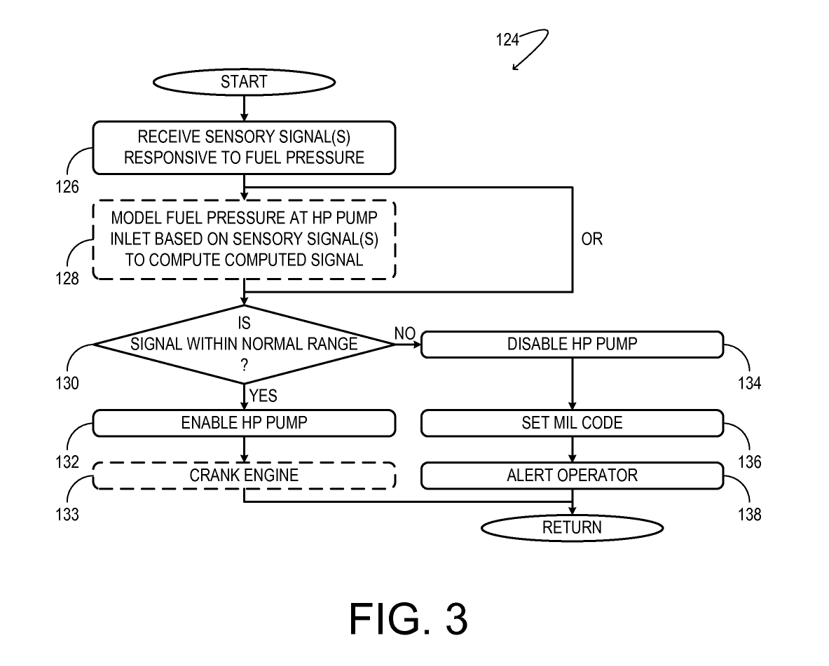

FIG. 3 illustrates an example method 124 to protect a high-pressure fuel pump in a diesel-engine system. At 126 of method 124, one or more sensory signals (e.g., voltages or currents) responsive to fuel pressure in the diesel-engine system are received. In the range of embodiments here contemplated, the received signal or signals may reflect fuel pressure at virtually any locus of the fuel system—e.g., at an inlet of the HP fuel pump, or at an outlet. Thus, a signal may be received from a fuel-rail pressure sensor coupled to a fuel rail in the diesel-engine system. In still other embodiments, the signal may be received from a low-pressure (e.g., delivery side) fuel pressure sensor or switch coupled upstream of the HP fuel pump in the diesel-engine system. Depending on the particular diesel-engine system in which method 124 is enacted, the signal may be a voltage or current from a low-pressure fuel pump coupled upstream of the HP fuel pump in the diesel-engine system. The low pressure pump that generates the pressure-indicating voltage or current may be lift pump or ITP, for example.

In the embodiments here contemplated, the manner of protection of the HP fuel pump may depend on the time frame in which the signal responsive to fuel pressure is interrogated. In one embodiment, where the primary object is to protect the HP fuel pump during startup, the signal may be received after key-on and before engine cranking. In other embodiments, the signal may be received during engine cranking, or at any time during engine operation. The term ‘key-on’ commonly refers to the state in which a vehicle operator has inserted a mechanical ignition key in the vehicle ignition switch, but has not yet turned the key to initiate engine cranking. However, the use of this term does not preclude other embodiments that use, for example, a keyless electronic control system to start the vehicle. In such embodiments, ‘key-on’ can alternatively refer to the state after a electronic ‘key’ is received in the electronic control system of the vehicle indicating that the vehicle is transitioned to an “on” statue. In one example, the key-on may include a remote key being present and communicating with the vehicle, and may be before or concurrent with an ignition button is pushed or a remote engine start request.

In some embodiments, one or more sensory signals may be used directly to indicate whether the HP fuel pump should be enabled or disabled. In other embodiments, the sensory signals are inputs to a computational algorithm which models a characteristic fuel pressure in the system—e.g., the pressure at the inlet of the HP fuel pump. Accordingly, at optional step 128 of method 124, a computed signal is computed by modeling the fuel pressure at the inlet based on the one or more sensory signals. A suitable fuel-pressure model, in some embodiments, may be based on the control signals sent to one or more control valves in the fuel system—i.e., a pressure-control valve coupled to a fuel rail, or a volume-control (metering) valve coupled in the HP fuel pump. The duty cycle signal to both the volume-control and pressure-control valves can be used to model the pressure, as each of these valves is a tightly machined orifice. Based on the duty cycle, fuel pressure can be modeled as liquid flow through an orifice. In some such embodiments, the fuel temperature may also affect the mapping between duty cycle and modeled fuel pressure.

At 130 it is determined whether any such signal (either the one or more sensory signals or a signal computed based on modeling a fuel-system pressure) is within its normal range. If the signal is within its normal range, then the method advances to 132, where the HP fuel pump is, or remains, enabled. Then, in particular scenarios in which the method is being enacted after key-on and prior to engine start, the engine is cranked at 133. However, the signal is not within its normal range, then the method advances to 134, where the HP fuel pump is disabled. More particularly, the action of disabling the HP fuel pump may be taken when if a transition in the signal from a normal to an abnormal range is detected, or simply upon any determination that the signal is outside of its normal range. In some embodiments, to protect the HP fuel pump during startup, the pump may be disabled during or prior to engine cranking. In other embodiments, the pump may be disabled after key-on and before engine cranking has begun. Naturally, engine cranking may be prevented or aborted whenever the HP fuel pump is disabled. In certain embodiments, for example, where the HP fuel pump is rigidly coupled to the crankshaft, the HP fuel pump may be disabled simply by preventing or aborting engine crank. Alternatively, the HP fuel pump may be disabled by disengaging a clutch that selectably couples the drive of the HP fuel pump to the crankshaft of the engine. In still other embodiments, the pump may be disabled after engine cranking, or any time during engine operation when it is determined that the fuel supply is inadequate to lubricate the pump. Notably, disablement of the HP fuel pump may enacted irrespective of temperature—e.g., fuel temperature, engine temperature, ambient temperature, etc.

Fuel pressure below the threshold may be indicative of air in the HP fuel pump or in a line configured to supply fuel to the HP fuel pump. Accordingly the HP fuel pump is enabled, in method 124, when fuel pressure in the diesel-engine system is above a threshold, and disabled if the fuel pressure at the inlet is below the threshold. In one embodiment, the threshold referred to herein may correspond to a lower limit of the range of the sensory signal, or of the computed signal, assuming that the signal increases with increasing fuel pressure.

Continuing in FIG. 3, at 136 of method 124 a MIL code specifically indicating HP fuel-pump shut-off due to inadequate fuel supply is set in the OBD system of the motor vehicle in which the diesel-engine system is installed. This action, in turn, may trigger the operator of the motor vehicle to be alerted, at 138, to the fact that the HP fuel pump has been disabled due to inadequate fuel supply. Moreover, as soon as such a fault is registered in the OBD system, subsequent enablement of the HP fuel pump (and subsequent engine cranking) may be disabled until the fault is reset by a service technician, or in some cases by a fuel-system refill or other operator input, such as via a user interface of the vehicle displaying the indication, instructions to the operator, and receiving an operator input. For example, in response to the fault being registered in the OBD system, in response to subsequent requests from the vehicle operator or the engine control system to crank and fuel the engine, the engine is not cranked and not fueled, and further the HP fuel pump is maintained disabled and not enabled. Note that the MIL code may be stored in non-transitory memory in the engine control system, and accessible by an external reader that correlates the code to an indication of degradation of the HP fuel pump.

It will be understood that the articles, systems, and methods described hereinabove are embodiments of this disclosure—non-limiting examples for which numerous variations and extensions are contemplated as well. This disclosure also includes all novel and non-obvious combinations and sub-combinations of the above articles, systems, and methods, and any and all equivalents thereof.

1. A method to protect a high-pressure fuel pump in a diesel-engine system, the method comprising:
enabling the high-pressure fuel pump when fuel pressure in the diesel-engine system is above a threshold, and
disabling the high-pressure fuel pump if the fuel pressure is below the threshold.

2. The method of claim 1 further comprising receiving a signal responsive to the fuel pressure, wherein enabling the high-pressure fuel pump includes enabling when the signal is within a normal range, and wherein disabling the high-pressure fuel pump includes disabling if the signal goes outside of the normal range.

3. The method of claim 2 wherein the signal is received from a fuel-rail pressure sensor coupled to a fuel rail in the diesel-engine system.

4. The method of claim 2 wherein the signal is received from a pressure-control valve coupled to a fuel rail in the diesel-engine system.

5. The method of claim 2 wherein the signal is received from a volume-control valve coupled in the high-pressure fuel pump.

6. The method of claim 2 wherein the signal is received from a low-pressure fuel pressure sensor or switch coupled upstream of the high-pressure fuel pump in the diesel-engine system.

7. The method of claim 2 wherein the signal is a voltage or current from a low-pressure fuel pump coupled upstream of the high-pressure fuel pump in the diesel-engine system.

8. The method of claim 2 wherein receiving the signal includes receiving after key-on and before engine cranking.

9. The method of claim 1 wherein disabling the high-pressure fuel pump is enacted during or prior to engine cranking.

10. The method of claim 1 wherein disabling the high-pressure fuel pump is enacted after engine cranking.

11. The method of claim 1 wherein disabling the high-pressure fuel pump is enacted irrespective of temperature.

12. The method of claim 1 wherein the fuel pressure below the threshold is indicative of air in the high-pressure fuel pump or in a line configured to supply fuel to the high-pressure fuel pump.

13. A diesel-engine system comprising:
a high-pressure fuel pump; and
a controller configured to receive a signal responsive to fuel pressure in the diesel-engine system, to enable the high-pressure fuel pump when the signal is within a normal range, and to disable the high-pressure fuel pump if the signal goes outside of the normal range.

14. The system of claim 13 further comprising a fuel-rail pressure sensor coupled to a fuel rail in the diesel-engine system, wherein the signal is received from the fuel-rail pressure sensor.

15. The system of claim 13 further comprising a pressure-control valve coupled to a fuel rail in the diesel-engine system, wherein the signal is received from the pressure-control valve.

16. The system of claim 13 further comprising a volume-control valve coupled in the high-pressure fuel pump, wherein the signal is received from the volume-control valve.

17. The system of claim 13 further comprising a low-pressure fuel pressure sensor or switch coupled upstream of the high-pressure fuel pump, wherein the signal is received from the low-pressure fuel pressure sensor or switch.

18. The system of claim 13 further comprising a low-pressure fuel pump coupled upstream of the high-pressure fuel pump, wherein the signal is a current or voltage from the low-pressure fuel pump.

19. A method to protect a high-pressure fuel pump in a diesel-engine system, the high-pressure fuel pump having an inlet, the method comprising:
after key-on and before engine cranking, receiving a signal responsive to the fuel pressure at the inlet;
enabling the high-pressure fuel pump when the signal is within a normal range; and
disabling the high-pressure fuel pump irrespective of temperature if the signal goes outside of the normal range, thereby indicating air in the high-pressure pump or in a line configured to supply fuel to the high-pressure pump.

20. The method of claim 19 wherein the signal is a computed signal, the method further comprising:
receiving one or more sensory signals from hardware components arranged in the diesel-engine system; and
computing the computed signal by modeling the fuel pressure at the inlet based on the one or more sensory signals.
